(19) United States
(12) Patent Application Publication
(10) Pub. No.: US 2002/0064678 A1
(43) Pub. Date: May 30, 2002

(54) Corrosion-resisting and wear-resisting alloy and device using the same

(76) Inventors: Yoshihisa Kiyotoki, Hitachinaka (JP); Yoshiteru Chiba, Hitachi (JP); Shin Kumagai, Tokai-mura (JP); Yasuhiro Ogawa, Choshi (JP); Akira Sakamoto, Mito (JP); Hiroyuki Shinohara, Tokyo. (JP)

Correspondence Address: MATTINGLY, STANGER & MALUR, INC., ATTORNEYS AT LAW, SUITE 370, 1800 DIAGONAL ROAD, ALEXANDRIA, VA, 22314, US

(21) Appl. No.: 09/939,591

(22) Filed: Aug. 28, 2001

(30) Foreign Application Priority Data
Aug. 28, 2000 (JP) 2000-263258
Aug. 3, 2001 (JP) 2001-235714

(51) Int. Cl. B32B 15/01; C22C 38/58; C22C 19/07; C22C 19/05

(52) U.S. Cl. 428/678; 277/406; 148/327; 148/410; 148/408

(57) ABSTRACT

To provide a corrosion-resisting and wear resisting alloy including cobalt, nickel or iron as a base used for a sliding part or a valve seat for a machine, and restraining erosion and corrosion caused by eutectic carbide constituting the alloy in an atmosphere with dissolved oxygen.

A material is selected from a cobalt base added with Cr and/or W, a nickel base added with Fe and/or Cr, and an iron vase added with Cr and/or Ni. The material is cast into an ingot or a slab to produce an intermediate material. The intermediate material comprises mesh-like eutectic carbide and a base material surrounded by the eutectic carbide. A heat plastic forming is applied to the intermediate material at a temperature 650° C. or more and the solidus temperature or less. The eutectic carbide is formed into multiple grains or clusters as a discontinuous distribution. A resulting corrosion-resisting and wear-resisting alloy has 0.1 to 0.5 of coefficient of friction, and 300 to 600 Hv of Vickers hardness without age-hardening process.

### BACKGROUND OF THE INVENTION

1. Field of the Invention

The present invention relates to a corrosion-resisting and wear-resisting alloy, and a fluid device and a dynamic device using the alloy.

2. Description of the Prior Art

A valve seat or a sliding part, where a corrosion-resisting and wear-resisting alloy which includes cobalt as a base, which is excellent in corrosion-resisting and wear-resisting capabilities, and has a high degree of hardness, and is added with Cr and/or W is overlaid to prevent an erosion damage on a valve seat during operation or a galling while a valve is in motion is used for valves such as a safety valve in a plant facility such as a turbine power generating facility.

In late years, hydrogen peroxide solution and the like is introduced to adjust water quality in a plant facility such as a turbine power generating facility. As the result, the amount of dissolved oxygen increases on the down stream of the introduction point, and an erosion damage is generated on eutectic carbide of the corrosion-resisting and wear-resisting alloy, which includes cobalt as a base, is added with Cr and/or W, comprises the eutectic carbide and the base material of a cast structure, and is overlaid on a seat surface of a valve and a sliding face to prevent erosion and a galling.

It is also reported that the base material of the cast structure is detached, thereby generating corrosion after the erosion damage of the eutectic carbide when a flow (such as water flow) is present.

The reports relevant to the earlier report include “Thermal and Nuclear Power Vol. 30-5 Processing Method for Boiler Water with Oxygen and Ammonia in a Steam System in a Thermal Power Plant”, “Damage on Machinery 1982 2 VEW Operation Experience in a Combined Operation Method at Gerstein Power Generating Plant”, and “Materials and Environment Vol. 47, No.3, Effect of Heat Treatment Condition on Grain Boundary Erosion at Welded Part of Cobalt-Base Alloy”.

Those reports conclude that there is no effective mean to eliminate a generation of the erosion, and it has been a problem.

On the other hand, an expansion valve preventing a generation of erosion at a valve port provided with an orifice by integrating an orifice member made of a metal material with higher degree of hardness (150 to 500 in Vickers hardness) than that of a valve body with the valve body is disclosed in Japanese application patent laid-open publication No. Hei 08-334280 (corresponding to U.S. Pat. No. 6,164,624 Specification).

An increased wear-resisting capability of a blade by attaching a bar-like wear-resisting material including cobalt, nickel, tungsten, manganese, and selenium to a rear edge of the steam turbine blade with friction surfacing is disclosed in Japanese application patent laid-open publication No Hei 05-208325 (corresponding U.S. Pat. No. 5,183,390 Specification). It is disclosed that a caution should be paid to avoid the bar-like wear-resisting material from presenting melting in terms of preventing a change in the degree of hardness and a crack due to shrinkage when the wear-resisting material is attached to the blade by friction surfacing, A valve where a valve seat comprising 30 to 45 weight % of Cr, 3.0 to 8.0 weight % of Ti, 0 to 10 weight % of Mo, and the balance Ni is diffusion-bonded to a valve element and a valve casing is disclosed in Japanese application patent laid-open publication No. Sho 59-179283.

A valve where a valve seat comprising 10 to 45 weight % of Cr, 1.5 to 6 weight % of at least either of Al or Ti, and 20 weight % or less of Mo, and the balance Ni is diffusion-bonded to a valve element and/or a valve casing is disclosed in Japanese application patent laid-open publication No. Sho 60-86239.

A valve where a valve seat comprising a cemented carbide material or a heat-resisting material is brazed through an amorphous alloy layer to a valve seat part of a valve casing is disclosed in Japanese application patent laid-open publication No. Hei 4-19476.

A technique where material of high carbon martensitic stainless steel is made into an intermediate material with an intermediate dimension with hot plastic forming, the intermediate material is applied with cold plastic forming, and the intermediate material is applied with the hot plastic forming again at 850° C. to obtain a steel material with an intended dimension is disclosed in Japanese application patent laid-open publication No. Hei 7-16610. The average dimension of the eutectic carbide in the steel material with the intended dimension reaches 4.2 micrometer with the disclosed technique in the publication.

Valves including safety valves used for a turbine power generating plant have a high flow speed at a valve seat during operation. Cobalt has a high degree of hardness, and is excellent in corrosion-resisting and wear-resisting capabilities. A valve seat which is made of a corrosion-resisting and wear-resisting alloy including cobalt as a base added with Cr and/or W is used for these valves.

A valve casing where the corrosion-resisting and wear-resisting alloy is used on a guide face for guiding a valve element, and on an inner face of a cage to prevent a galling while a vale is in operation, is used for a cage valve.

However, when the aforementioned valve seat made of the corrosion-resisting and wear-resisting alloy is used in a high temperature/high pressure water/steam atmosphere with high dissolved oxygen, a base material layer of a cast structure and eutectic carbide surrounding the base material layer of the cast structure as a mesh shape in the alloy are selectively corroded by the dissolved oxygen in the fluid. This makes the surface of the valve seat rougher, the eutectic carbide is corroded and detached with an additional effect of a tunnel effect (F. j. Heymann: Machine Design. 42, 118 (1970)), which is caused by a penetration of a high speed jet into a corroded and damaged part, the base material of the cast structure which lost the support from the mesh-like eutectic carbide is easily detached by the flow, resulting in a generation of an erosion in the corrosion-resisting and wear-resisting alloy.

### SUMMARY OF THE INVENTION

The purpose of the present invention is to provide a corrosion-resisting and wear-resisting alloy with increased corrosion-resisting and erosion-resisting capabilities by restraining continuing corrosion of eutectic carbide in the corrosion-resisting and wear-resisting alloy in an atmosphere with dissolved oxygen.

The purpose of the present invention is also to provide devices where the corrosion-resisting and wear-resisting alloy with increased wear-resisting and corrosion-resisting capabilities is used at wear-resisting parts and erosion-shield parts.

The principal part of the present invention to attain the purpose is described below.

A corrosion-resisting and wear-resisting alloy is obtained by selecting a material from cobalt base added with Cr and/or W, nickel base added with Fe and/or Cr, and iron base added with Cr and/or Ni, casting the material into an ingot or a slab as an intermediate material, applying hot plastic forming at a temperature which is 650° C. or more and the solidus temperature or less to the intermediate material, which includes a structure comprising mesh-like eutectic carbide and a base material surrounded by it, forming the eutectic carbide as a discontinuous distribution in a form of multiple grains or clusters. The coefficient of friction of the corrosion-resisting and wear-resisting alloy is 0.1 to 0.5, and the Vickers hardness without age hardening process of it is 300 to 600 Hv.

The cobalt base added with Cr and/or W comprises 0.1 to 3.5% of C, 25% or less of Ni, 25 to 35% of Cr, 5% or less of Fe, 20% or less of W, 1.5% or less of Mn, and 1.5% or less of Si in weight ratio, the balance Co and inevitable impurities. The nickel base added with Fe and/or Cr comprises 0.1 to 2.5% of C, 3 to 9% of Si, 7 to 25% of Cr, 0.5 to 5% of B, 2 to 6% of Fe, 1 to 5% of W, and 17% or less of Mo in weight ratio, the balance Ni and inevitable impurities. The iron base added with Cr and/or Ni comprises 0.1 to 1.5% of C, 0.3 to 4% of Si, 4 to 9% of Ni, 3% or less of Mo, 6 to 10% of Mn, and 15 to 25% of Cr in weight ratio, the balance Fe and inevitable impurities.

For example, cobalt base added with Cr and/or W is cast into an intermediate material typified by an ingot or a slab. This cast material comprises a base material and eutectic carbide of a cast structure. A hot plastic forming is applied to the eutectic carbide, which has a high degree of hardness and low ductility, and is fragile and distributed continuously as a mesh. The intermediate material becomes fine grains or clusters. The structure of the base material penetrates into gaps generated in the eutectic carbide. The base material with a low degree of hardness, high ductility, and strength is distributed around the grain-like or cluster-like eutectic carbide, thereby making the eutectic carbide discontinuous.

Simultaneously, the diffusion of large amount of chrome existing in the eutectic carbide is accelerated by maintaining it at 650° C. or more, thereby reducing chrome-deficiency layers around the eutectic carbide, resulting in a corrosion-resisting and wear-resisting alloy simultaneously having an increased corrosion-resisting capability of the eutectic carbide.

With this, eutectic carbide, which is distributed as mesh, and is in a cast structure which is made by dissolving cobalt as a base along with Cr and/or W and comprises the base material and the eutectic carbide, is made into multiple clusters and grains as discontinued eutectic carbide, thereby making an erosion phenomenon discontinued, very shallow and partial.

As the result, the progress of the erosion is restrained, and a tunnel effect (F. j. Heymann: Machine Design. 42, 118 (1970)), which is caused by a penetration of. a high speed jet into a corroded and damaged part is restrained, thereby increasing the erosion/corrosion-resisting capability.

The effect described above increases the erosion-resisting and corrosion-resisting capabilities.

Also, the diffusion of large amount of chrome existing in the eutectic carbide into the periphery of the eutectic carbide is accelerated by maintaining it at 650° C. or more, thereby reducing chrome-deficiency layers around the eutectic carbide containing Cr, resulting in a corrosion-resisting and wear-resisting alloy simultaneously having an increased corrosion-resisting capability of the eutectic carbide.

For a nickel base material added with Fe and/or Cr, or an iron base material added with Cr and/or Ni, a corrosion-resisting and wear-resisting material is obtained in the same way, thereby increasing erosion/corrosion-resisting capability.

When the corrosion-resisting and wear-resisting alloy is partially or entirely melted, the eutectic carbide at the melted part forms mesh-like eutectic carbide with a low corrosion-resisting capability. Thus, the corrosion-resisting and wear-resisting alloy is machined into an arbitrary shape, and is used after it is joined without melting to a base metal, which is a base to which the corrosion-resisting and wear-resisting alloy is attached.

Since the mesh-like eutectic carbide does not exist, and is made into clusters or grains, a fluid machine using the alloy such as a pump, a valve, a pressure device, and a turbine presents high corrosion/erosion-resisting capabilities under a corrosive atmosphere.

A dynamic machine such as a pump, a valve, a turbine, and an engine where the corrosion-resisting and wear-resisting alloy without chanting the metal composition is joined to a base metal and used for a sliding part or a contact part, presents high corrosion/erosion-resisting capability under a corrosive atmosphere.

The obtained coefficient of friction can be 0.1 to 0.3, which is as low as diamond (coefficient of friction of 0.1 when no lubricant), sapphire (coefficient of friction of 0.2 when no lubricant), and ruby, thereby reducing friction resistance compared with 0.35 to 0.8 of other metals such as brass (coefficient of friction of 0.35 when no lubricant) and steel (coefficient of friction of 0.8 when no lubricant).

The corrosion-resisting and wear-resisting alloy is used for a wear-resisting part or an erosion shield for a fluid machine, and a sliding part or a contact part for a dynamic machine.

When the corrosion-resisting and wear-resisting alloy of the present invention is attached to a fluid machine or a dynamic machine, it is attached to the wear-resisting part and the erosion shield part, and the sliding part and the contact part while maintaining the composition of the corrosion-resisting and wear-resisting alloy as much as possible. As the attaching method, a joining method which does not melt the corrosion-resisting and wear-resisting alloy is employed. As an example of the joining method, liquid phase diffusion welding is available.

More specifically, the corrosion-resisting and wear-resisting alloy of the present invention is applied to a valve seat attached to contact faces of a valve element and a valve casing provided on a piping system in an atomic power generating plant and the like, a contact face material for at least either of contact faces of a seat or a washer rotating relatively to each other about a rotating shaft of a pump, valve seats attached to contact faces of a valve seat part and a valve provided on a cylinder head of an internal combustion engine, and a contact face material for at least either of contact faces of a valve lifter and a cam of an internal combustion engine.

The present invention reduces the degradation of entire corrosion-resisting and wear-resisting capabilities caused by corrosion and damage to eutectic carbide in a corrosion-resisting and wear-resisting alloy.

Applying the corrosion-resisting and wear-resisting alloy of the present invention to sliding parts and contact parts of different devices reduces roughness on the sliding parts and the contact parts of the devices caused by the corrosion and the damage of the eutectic carbide under a corrosive environment, thereby maintaining proper friction resistance on the sliding parts and the contact parts. As the result, the present invention provides devices including sliding faces and contact faces with low friction.

A rotating device, which is an embodiment of the present invention, includes a mechanical seal device sealing between a rotating shaft and a casing. The mechanical seal device comprises a first seal, which rotates with the rotating shaft, and a second seal, which is installed on the casing, and is in contact with the first seal. At least either the first seal or the second seal is a corrosion-resisting and wear-resisting part where grain-like or cluster-like eutectic carbide is diffused in the matrix part of the metal micro structure, and includes the corrosion-resisting and wear-resisting alloy part which comes in contact with the other seal part, and a main body. The corrosion-resisting and wear-resisting alloy part is diffusion-welded to the main body. Since the seal part includes the corrosion-resisting and wear-resisting alloy part, which is diffusion-welded to the main body, the corrosion-resisting and wear-resisting alloy part, which is diffusion-welded, includes grain-like or cluster-like eutectic carbide as described before, not mesh-like eutectic carbide. Seizure, wear, and acceleration of corrosion of the seal member caused by an increase of the temperature at the seal due to heat generated at the contact part of the first and the second seals is restrained, thereby increasing the corrosion-resisting and wear-resisting capabilities at the seal, decreasing the frequency of maintenance for the mechanical seal device including the first and second seals, and increasing the life of the mechanical seal device. This leads to relieving the maintenance operation for the rotating device. Since the corrosion-resisting and wear-resisting alloy has a small coefficient of friction, the heat energy generated at the contact part of the first seal and the second seal decreases. This leads to a reduction of the power rotating the rotating shaft of the rotating device.

### BRIEF DESCRIPTION OF THE DRAWINGS

FIG. 1 is an SEM photograph indicating a metal structure of a surface of a corrosion-resisting and wear-resisting alloy including cobalt as a base added with Cr and/or W (a), and its schematic (b).

FIG. 2 is an enlarged part (a) of the metal structure of the corrosion-resisting and wear-resisting alloy from FIG. 1, and its schematic (b).

FIG. 3 is a metal structure indicated by a face analysis of a surface of a corrosion-resisting and wear-resisting alloy including cobalt as a base added with Cr and/or W (a), and its schematic (b).

FIG. 4 is a metal structure of a surface of a corrosion-resisting and wear-resisting alloy including cobalt as a base added with Cr and/or W after heat plastic forming (a), and its schematic (b).

FIG. 5 is a metal structure indicated by a face analysis of a surface of a corrosion-resisting and wear-resisting alloy including cobalt as a base added with Cr and/or W after heat plastic forming (a), and its schematic (b).

FIG. 6 is a schematic of a repeated progress of a damage caused by dissolved oxygen on a corrosion-resisting and wear-resisting alloy including cobalt as a base added with Cr and/or W.

FIG. 7 is a schematic of a restraining status of a damage caused by dissolved oxygen on a corrosion-resisting and wear-resisting alloy including cobalt as a base added with Cr and/or W after heat plastic forming.

FIG. 8 is a SEM photograph indicating a metal structure obtained by a Strauss test applied to a corrosion-resisting and wear-resisting alloy including cobalt as a base added with Cr and/or W after heat plastic forming.

FIG. 9 is a chart indicating a coefficient of friction obtained by a sliding test applied to a corrosion-resisting and wear-resisting alloy including cobalt as a base added with Cr and/or W after heat plastic forming.

FIG. 10 is a piping system diagram of a nuclear power generating plant.

FIG. 11 is a lengthwise section view of a gate valve adopted for the piping system of the nuclear power generating plant

FIG. 12 is a section view indicating contact states between a valve element and individual valve seats, and between a valve casing and the individual valve seats for the gate valve in FIG. 11.

FIG. 13 is an entire view of an internal combustion engine with a partial section view.

FIG. 14 is an enlarged section view around a valve indicated in FIG. 13.

FIG. 15 is an enlarged section view of a contact part between the valve and a seat in FIG. 14.

FIG. 16 is a section view of a pump.

FIG. 17 is a section view of a neighborhood of a mechanical seal of a pump in FIG. 16.

### DESCRIPTION OF THE PREFERRRED EMBODIMENT

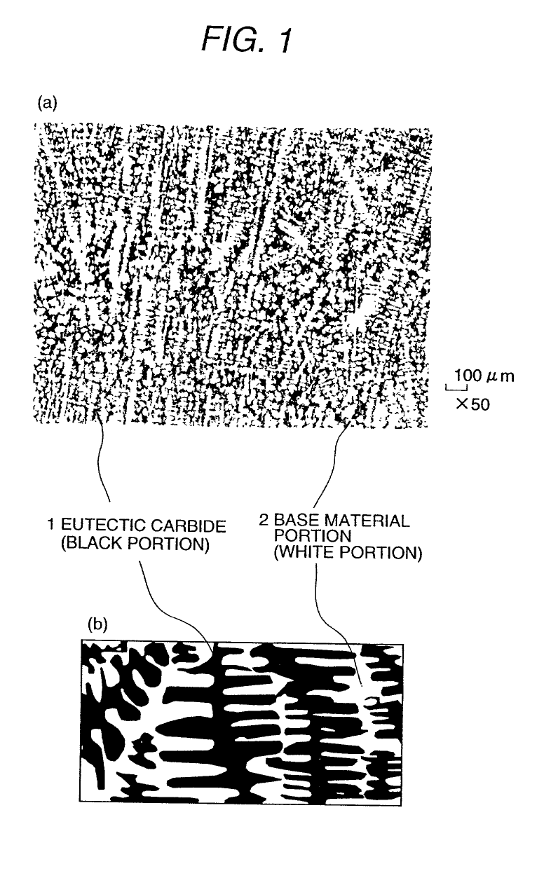

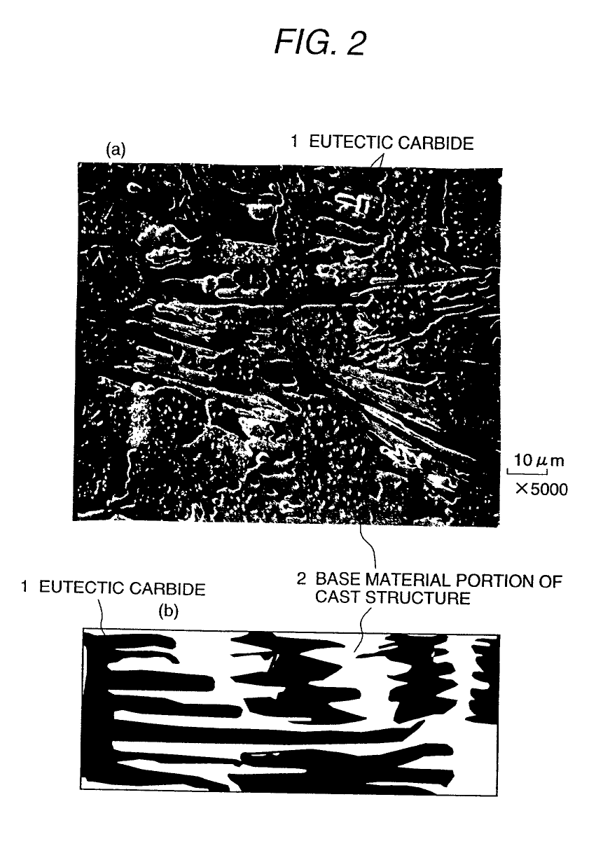

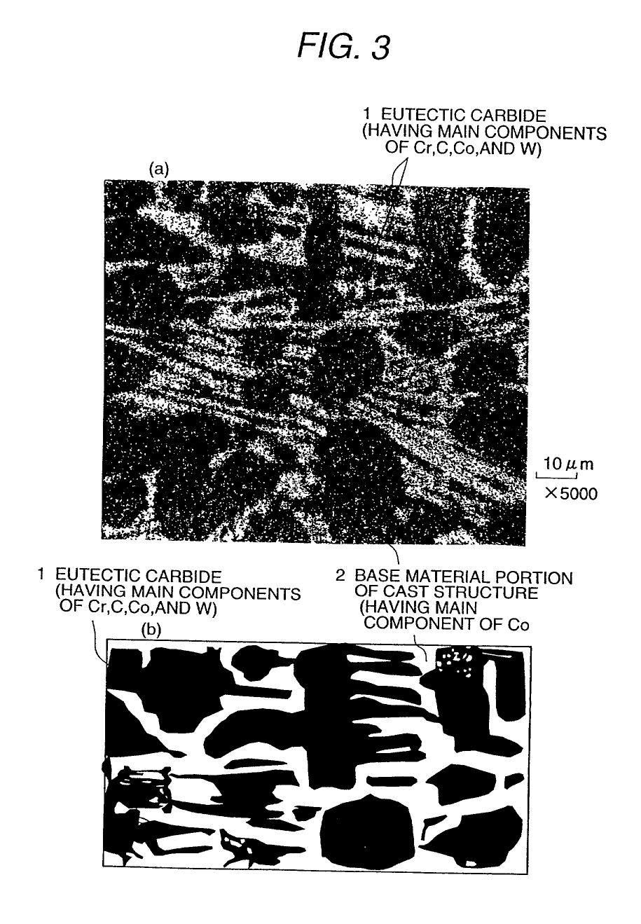

A typical SEM photograph of a surface of a corrosion-resisting and wear-resisting alloy including cobalt as a base added with Cr and/or W is shown in FIG. 1 (Note that (a) is an SEM photograph, (b) is the schematic of (a). Same arrangement is repeated in FIGS. 2 to 5). An SEM photograph with a high magnitude is shown in FIG. 2. An SEM photograph for Cr face analysis taken at the same position on the face of the corrosion-resisting and wear-resisting alloy as in FIG. 2 is shown in FIG. 3.

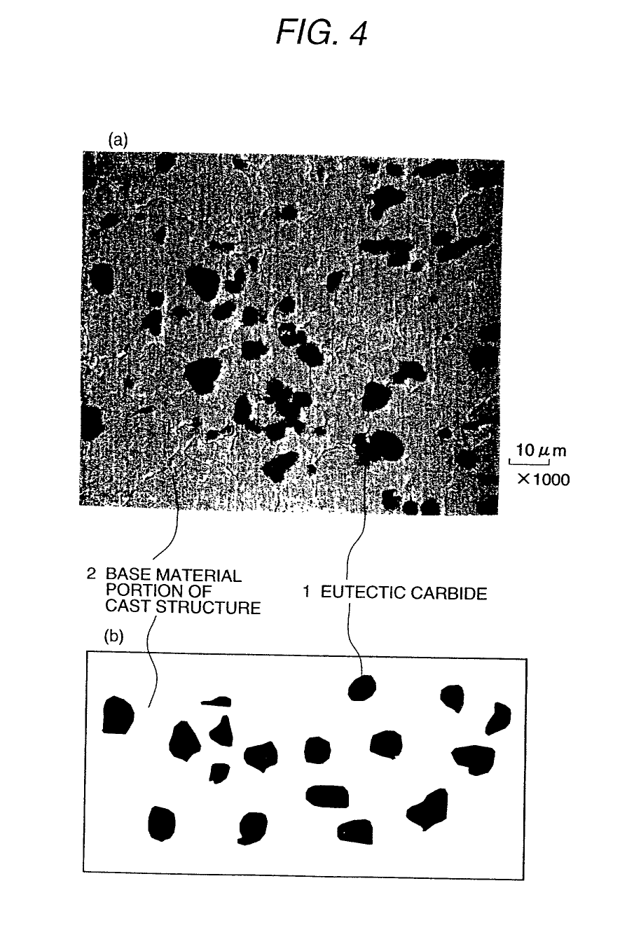

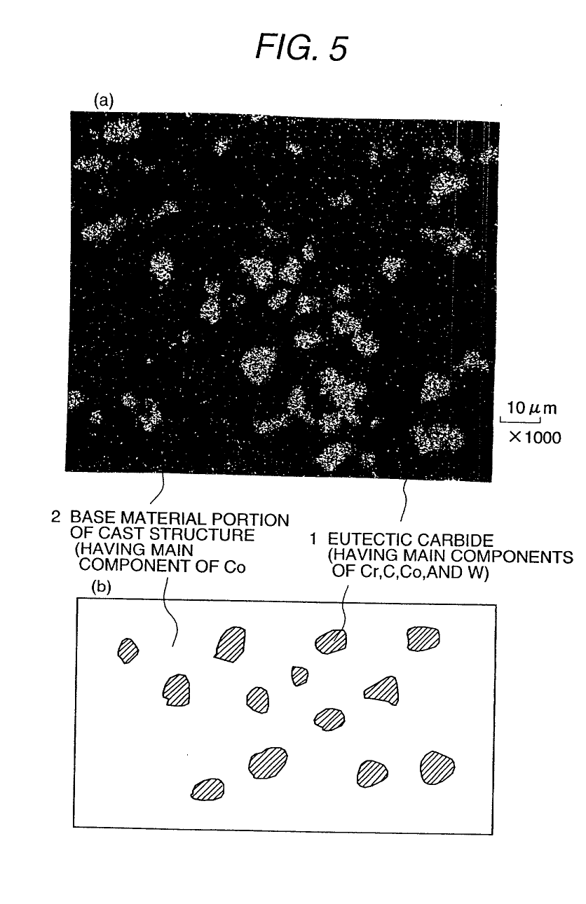

An SEM image of a metal structure of a face of the corrosion-resisting and wear-resisting alloy after hot plastic forming such as forging and rolling is shown in FIG. 4. An SEM photograph for Cr face analysis taken at the same position on the face of the corrosion-resisting and wear-resisting alloy as in FIG. 4 is shown in FIG. 5.

Eutectic carbide 1 with principal components of Cr and C in FIGS. 1, 2, and 3 is continuously distributed as a mesh in a base material 2 of a cast structure including cobalt as a principal component on a surface of the surface-melted alloy.

An embodiment of the present invention is shown in FIGS. 4 and 5. The eutectic carbide 1 is distributed as grains or clusters with respect to the base material 2 uniformly but discontinuously on a surface of the corrosion-resisting and wear-resisting alloy. The eutectic carbide 1 changes from mesh to grains or clusters, thereby reducing the ratio of the eutectic carbide occupying the surface.

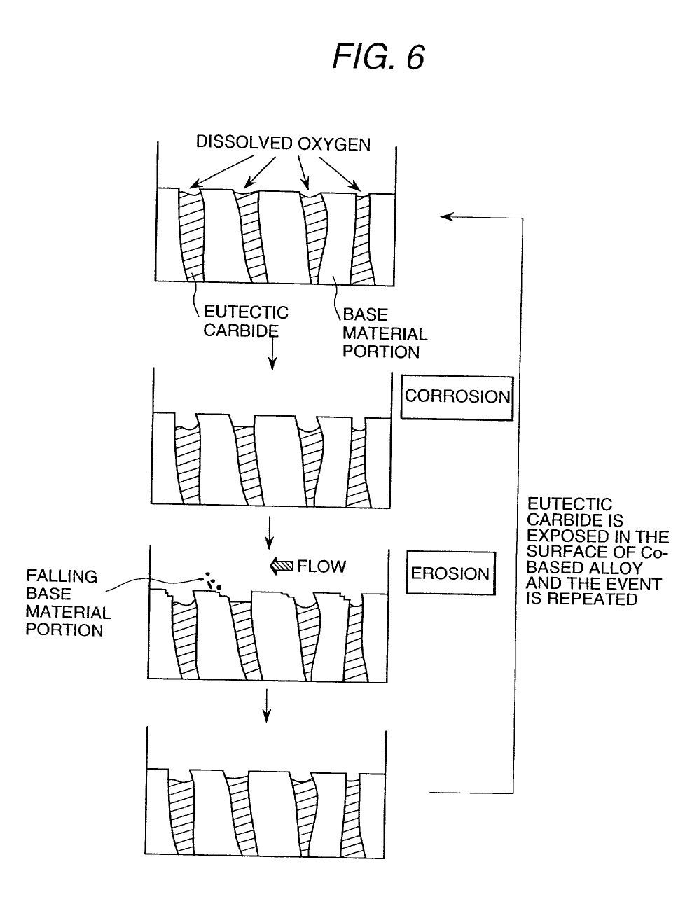

FIG. 6 is a schematic showing a progress of repeated damage to the corrosion-resisting and wear-resisting alloy including cobalt as a base added with Cr and/or W due to dissolved oxygen.

As the corrosion/erosion on the corrosion-resisting and wear-resisting alloy progresses, the base layer 2 of the cast structure tends to detach because the dissolved oxygen corrodes the eutectic carbide 1.

As indicated in the SEA photograph in FIG. 3, the eutectic carbide 1 continuous as a mesh exists in the conventional corrosion-resisting and wear-resisting alloy including cobalt as a base added with Cr and/or W. The corrosion of the eutectic carbide 1 and the detaching of the base layer 2 of the cast structure due to the dissolved oxygen occur continuously, resulting in a progress of the corrosion/erosion under an atmosphere of dissolved oxygen.

On the other hand, in the corrosion-resisting and wear-resisting alloy which includes cobalt as a base added with Cr and/or W, and is applied with hot plastic forming, the eutectic carbide 1 exists discontinuously as grains or clusters, the corrosive damage to the eutectic carbide 1 due to the dissolved oxygen is limited to the eutectic carbide 1 on a face facing to the dissolved oxygen.

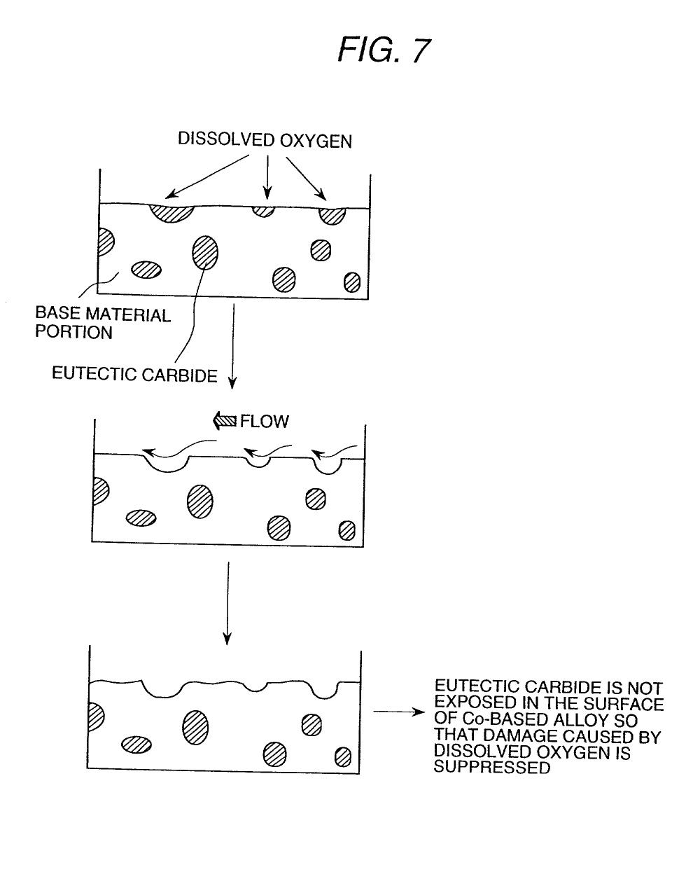

After the eutectic carbide 1 on the surface is corroded and. detached, the corrosive damage does not progress any further. This is described using a schematic in FIG. 7 showing a restrained damage due to the dissolved oxygen.

To verify the effect described before, JIS G 0575 “Sulfuric acid/cupric sulphate corrosion test on stainless steel” (Strauss test) is applied. According to a test conducted by Takahisa and Honda where a similar test was applied to a corrosion-resisting and wear-resisting alloy of cobalt base including a mesh-like continuous distribution of eutectic carbide (Materials and Environment Vol. 47, No.3, Effect of Heat Treatment condition on Grain Boundary Erosion at Welded Part of Cobalt-Base Alloy), it is reported that a progress of a corrosion is observed at surface-melted alloy of the corrosion-resisting and wear-resisting alloy of cobalt base.

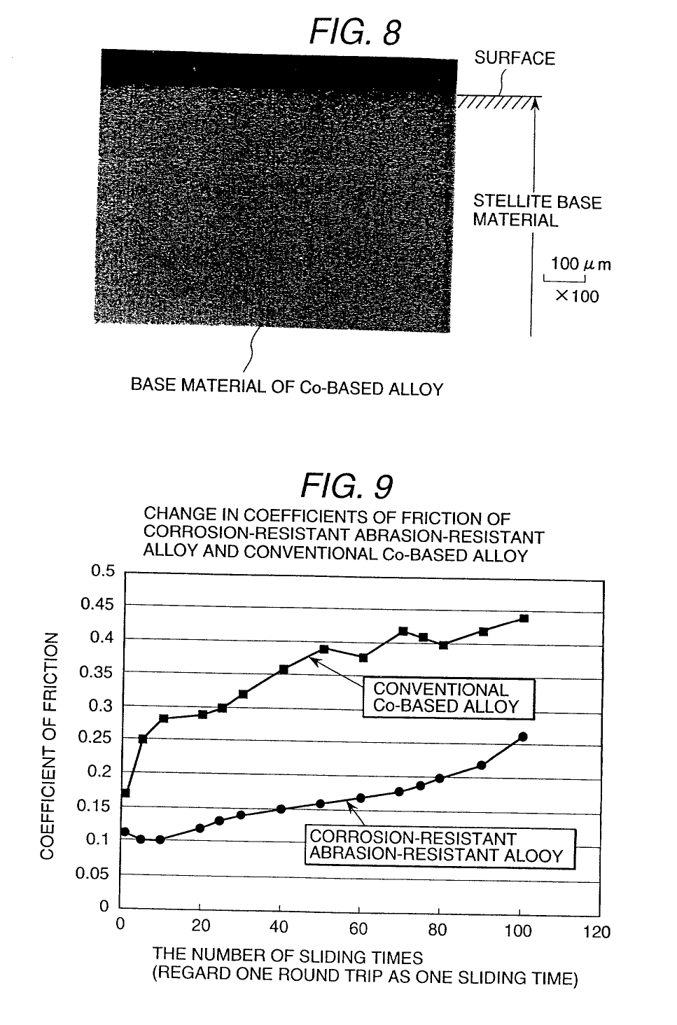

The similar test is applied to the corrosion-resisting and wear-resisting alloy of cobalt base added with Cr and/or W after a plastic forming such as forging and rolling, little etching was observed on the surface, no progress of a corrosion is present into the depth direction, and an excellent corrosion-resisting capability is confirmed. The test result is presented in FIG. 8 and Table 1. FIG. 9 shows a measuring result of the coefficient of friction with respect to the increase/decrease of the number of sliding.

TABLE 1
Strauss test: Corrosion depth in Co-base alloy (mm)

| | Co-base alloy with | Co-base alloy with eutectic | |
|---|---|---|---|
| | eutectic carbide with | carbide with discontinuous | |
| | continuous mesh-like | grain- or cluster-like | |
| Material | distribution | distribution | |
| Pre-heating | 600° C. | 600° C. | 700° C. |
| temperature | | | |
| Testing | 0.51 to 0.62 mm | As slight as | No damage |
| period | | etching | |
| 16 hours | | impossible to | |
| | | measure) | |
| Testing | 3 mm or more | Up to 0.1 mm | As slight as |
| period | | | etching |
| 150 hours | | | (impossible to |
| | | | measure) |

The corrosion depth under a corrosive environment for the corrosion-resisting and wear-resisting alloy of cobalt base added with Cr and/or W, where the eutectic carbide 1 is distributed discontinuously as grains or clusters, the corrosion depth is restrained to about 1/30 of that of conventional alloys, and the corrosion depth is restrained further by increasing a pre-heating temperature to diffuse Cr further.

As the result, the corrosion-resisting and wear-resisting alloy with the eutectic carbide 1 distributed discontinuously as grains or clusters restrains the corrosion due to the dissolved oxygen, resulting in restraining the erosion.

When the cases where pre-heating temperature of the corrosion-resisting and wear-resisting alloy of cobalt base added with Cr and/or W is about 600° C. and is 700° C. are compared, the corrosion-resisting capability of the grain-like or cluster-like eutectic carbide 1 presents higher corrosion-resisting capability in the case for 700° C., where Cr diffuses more, and joining the alloy with the base material at a higher pre-heating temperature provides better corrosion-resisting and wear-resisting capabilities.

For a corrosion-resisting and wear-resisting alloy of nickel base added with Fe and/or Cr, and a corrosion-resisting and wear-resisting alloy of iron base added with Cr and/or Ni, conducting heat plastic forming in a state heated up to the solidus temperature or less increases the corrosion-resisting and wear-resisting capabilities as for the corrosion-resisting and wear-resisting alloy of cobalt base added with Cr and/or W, simultaneously providing a sliding surface with a low friction.

For a corrosion-resisting and wear-resisting alloy of iron base added with Cr and/or Ni, conducting heat plastic forming in a state heated up to the solidus temperature or less increases the corrosion-resisting and wear-resisting capabilities as for the corrosion-resisting and wear-resisting alloy of cobalt base added with Cr and/or W, simultaneously providing a sliding surface with a low friction.

The material components of the corrosion-resisting and wear-resisting alloy of cobalt base added with Cr and/or W comprises 0.1 to 3.5% of C, 25% or less of Ni, 25 to 35% of Cr, 5% or less of Fe, 20% or less of W, 1.5% or less of Mo, and 1.5% or less of Si in weight ratio, the balance Co and inevitable impurities.

The material components of the corrosion-resisting and wear-resisting alloy of nickel base added with Fe and/or Cr comprises 0.1 to 2.5% of C, 3 to 9% of Si, 7 to 25% of Cr, 0.5 to 5% of B, 2 to 6% of Fe, 1 to 5% of W, and 17% or less of Mo in weight ratio, the balance Ni and inevitable impurities.

The material components of the corrosion-resisting and wear-resisting alloy of iron base added with Cr and/or Ni comprises 0.1 to 1.5% of C, 0.3 to 4% of Si, 4 to 9% of Ni, 3% or less of Mo, 6 to 10% of Mn, and to 25% of Cr in weight ratio, the balance Fe and inevitable impurities.

Applying a hot plastic forming to these corrosion-resisting and wear-resisting alloys increases the corrosion-resisting and wear-resisting capabilities, simultaneously providing a corrosion-resisting and wear-resisting sliding surface with a low friction.

The average coefficient of friction obtained by measuring friction of a face of the corrosion-resisting and wear-resisting alloy is 0.16 without lubrication in a room atmosphere, and is 0.19 in a saturated steam atmosphere at 288° C. The metal components of the corrosion-resisting and wear-resisting alloy used for the friction measuring are described in Table 2, and the eutectic carbide in the corrosion-resisting and wear-resisting alloy takes a form of discontinuous distribution of multiple grains or clusters.

TABLE 2

| Composi- | | | | | | | | |
|---|---|---|---|---|---|---|---|---|
| tion | Ni | Fe | Mo | C | Si | Cr | Co | W |
| Weight % | 2.59 | 2.67 | 0.07 | 1.03 | 0.59 | 29.73 | Balance | 3.86 |

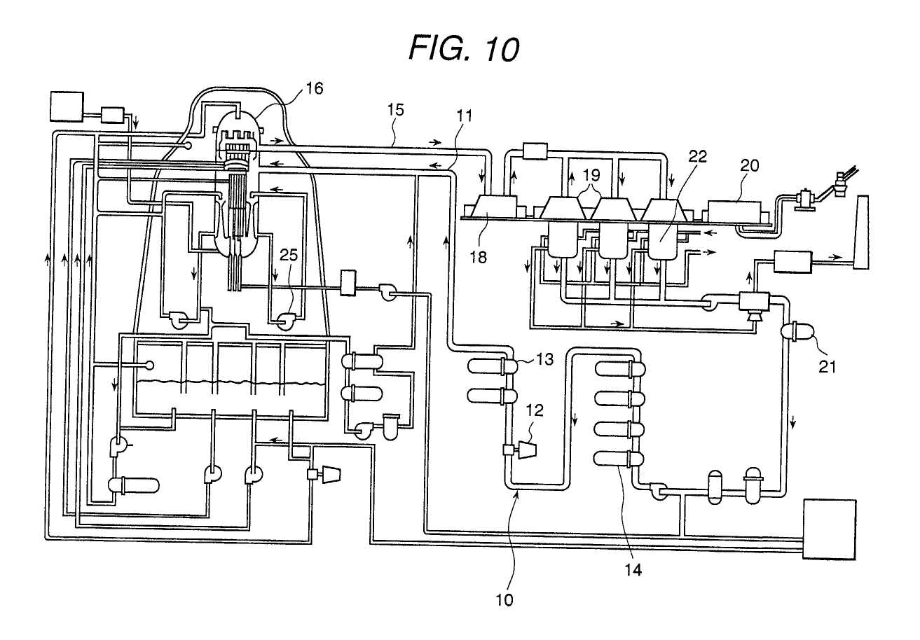

The corrosion-resisting and wear-resisting alloy of the present invention is used for different devices as described below. FIG. 10 presents a piping system for a nuclear power generating plant. A large number of gate valves and check valves are installed on a water supplying pipe 11 of the piping system 10. Since the gate valves and check valves installed on the water supplying pipe 11 are smaller than a water-supplying pump 12, individual supplied water heaters 13, 14, and other devices installed in the course of the water supplying pipe 11, and the number of the gate valves and check valves is very large, the graphical representation of the gate valves and the check valves are suppressed.

In the nuclear power generating plant, high temperature and high pressure steam obtained inside a nuclear reactor pressure vessel 16 is introduced into a high pressure turbine 18 through a main steam piping 15. Then the steam exhausted from the high pressure turbine 18 is introduced to a low pressure turbine 19. The rotating forces of these turbines drive a generator 20. The steam which has passed through the high pressure turbine 18 and the low pressure turbine 19 is exhausted from the high pressure turbine 18 and the low pressure turbine 19, and is condensed into water in a main condenser 22 and a gland steam condenser 21. The water is returned to the nuclear reactor pressure vessel 16 through the water supplying system 10 including the gate valves and the check valves in addition to the water supplying pump 12, the individual supplied water heaters 13, 14, and the water supplying pipe 11.

The following section describes an example where the present invention is applied to a gate valve among the valves adopted for the piping of a water supplying system 46.

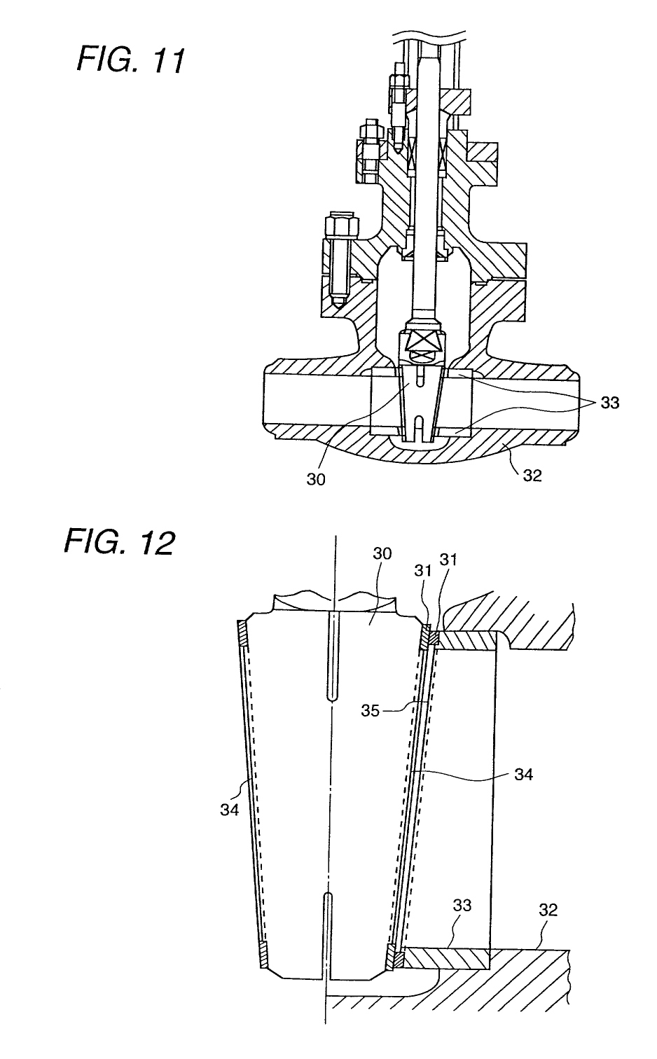

The FIG. 11 shows a lengthwise section of the gate valve installed on the water supplying pipe 11 of the water supplying system 10. As in FIG. 12, a ring-like plate 31 made of a cobalt-base alloy is mounted as a valve seat on a valve element 30 side of the gate valve. The ring-like plate 31 made of the cobalt-base alloy is also installed on a slide face of a valve seat 33 of a valve casing 32 side.

The cobalt-base alloy includes 1.0 weight % of C, 30.0 weight % of Cr, and 3.9 weight % of W. Eutectic carbide in the cobalt-base alloy is made into clusters or grains less than 30 micrometer by heat forging or heat rolling the cobalt-base alloy. The cobalt-base alloy plate 31 is joined to the valve seat 33 of the valve casing 32 and a valve seat part of the valve element 30 with liquid phase diffusion welding as indicated in FIG. 12.

The valve element 30 of the gate valve takes a disk-like shape, which is thick at the top and thin at the bottom, and is driven upward/downward in association with the upward/downward motion of a valve stem, thereby opening/closing a flow of water or steam flowing into the valve casing 32 in the left/right direction in the Figure.

The following section describes a specific example for installing a ring-like plate made of the cobalt-base alloy 31 to the valve element 30. Protrusions 34 protruding toward left and right is provided by providing steps on the left and the right surfaces of the valve element 30 of the gate valve. An insert material for joining is placed in recessed part which is generated by providing the steps. The ring-like plate 31 with thick ness of about 7 mm is placed on the surface of the insert material for joining such that the plate 31 is engaged with the protrusions 34. Only the insert material for joining is melted to attach the ring-like plate 31 to the valve element 30 with liquid phase diffusion welding.

The insert material used for the liquid phase diffusion welding is an Ni-base alloy including 4.5 weight % of Si and 3 weight % of B, and is fully melted at about 1040° C. or more. The condition for the liquid phase diffusion welding is 1100° C. for the joining temperature, 1 hour for the maintained period, 1 to 2 mult 10⁻⁴ Torr for the degree of vacuum, and 15 g/cm² for the applied pressure. For the cooling after the joining, about 150° C./h is from 1000° C. to 650° C., about 100° C./h is from 650° C. to 425° C., and natural cooling with air cooling in room is from 425° C.

A ring-like protrusion 35 is also machined on the valve seat 33. An insert material for joining is placed in a recessed part around the protrusion. The ring-like plate 31 with thick ness of about 7 mm is placed on the surface of the insert material for joining to engage with the protrusion 35. Only the insert material for joining is melted to attach the ring-like plate 31 to a valve seat 7 with liquid phase diffusion welding. The ring-like plate 31, the material for joining, the conditions for the liquid phase diffusion welding, and the cooling condition are the same as those for the joining of the valve element 30 to the plate 31.

The valve element 30, the plate 31 and the valve seat 33 do not melt at the joining temperature of 1100° C. Material of a part of the valve element 30 and the valve seat 33 where the plates 31 are installed is S25C, carbon steel for machine structure. The thermal expansion coefficient of the carbon steel for machine structure S25C is smaller than that of the Co-base alloy. The ring-like protrusions 34, 35 (steps) with the height of 2 mm are provided to internally come in contact with a ring-like plates 6 to be joined on the surfaces of the valve element 30 and the valve seat 33 opposing to each other as described in FIG. 12. This facilitates positioning the plates 31 to the valve element 30 and the valve seat 33 during the joining, and simultaneously increasing a resistance against a searing force added to a sliding part and the joined part when the gate vale is in operation.

Both of the plates 31 which serve as a valve seat on the valve element 30 side appear as a ring seen from the left and the right of the page respectively in FIG. 12. The ring-like plates 31 are joined such that they are in contact with the outer periphery of the circular protrusion 34 on the left and right sides of the valve element 30.

The valve seat 33 on the side of the valve casing 32 is cylindrical, and a valve set 33 is integrated into the valve casing 32. An end face on the side of the valve element 30 of the valve seat 33 is a sliding face. The end face is structured such that the ring like plate 31 is in contact with and is liquid-phase-diffusion welded to the outer periphery of the ring-like protrusion 35. Both of the protrusions 34, 35 are 2 mm in height, which is smaller than 7 mm of the thickness of the ring-like plates 31.

For the gate valve manufactured with this method, the mutual contact faces of the valve element and the valve casing are structured with the plates 31. Since the eutectic carbide in the Co-base alloy, which is the material for the plate 31, is distributed discontinuously as multiple grains or clusters after the liquid phase diffusion welding, the phenomenon that an atmosphere generating a corrosive environment such as dissolved oxygen corrodes the eutectic carbide continuously is restrained. This restrains the detach of matrix of the cast structure of the Co-base alloy, thereby restraining the progress of the corrosion and erosion of the valve seat, resulting in preventing the deterioration of the leakage-resisting capability of the gate valve.

For this embodiment, the Co-base alloy plates 31 are used as the ring-like corrosion-resisting and wear-resisting alloy. As described before, the corrosion-resisting and wear-resisting alloy of nickel base added with Fe and/or Cr, the corrosion-resisting and wear-resisting alloy of iron base added with Cr and/or Ni, and the Ni-base alloy and the Fe-base alloy, where the alloy including components described before in the Table 2 is applied with heat forging or heat rolling to make the eutectic carbide in the alloy distribute discontinuously are used as well.

Though in this embodiment, Ni-base alloy with a low melting point is used as an insert material, an Fe-base or Co-base insert with a low melting point is used as well. The same constitution as in the embodiment of the present invention can be applied to a sliding part and a contact part of a valve seat and the like in a check valve, a safety valve, and a globe valve in addition to a gate valve to provide an effect on restraining the decrease of the leakage-resisting capability, the controllability and the operation capability of the individual valves.

This embodiment has an effect of maintaining the normal function of a valve used for an atomic power generating plant for a long period, thereby increasing the reliability of the atomic power generating plant with the effect.

In a plant including a piping system integrated with the valve described in this embodiment, corrosion and erosion of sliding parts such as a valve seat due to dissolved oxygen are restrained when hydrogen peroxide solution is infused in the piping for the purpose of adjusting water quality, thereby providing an effect on the increase of the safety of the plant.

Especially, when the valve of the present embodiment is installed and used on a water supplying system of a nuclear power generating plant, corrosion and detaching of the eutectic carbide of the Co-base alloy applied to the valve seat, and effusion and diffusion of cobalt into the water supplying system after the corrosion and the detaching are restrained. As the result, the effusion and diffusion of the cobalt and the activation of the cobalt are restrained, thereby remarkably reducing exposure to radiation of workers in the nuclear power generating plant.

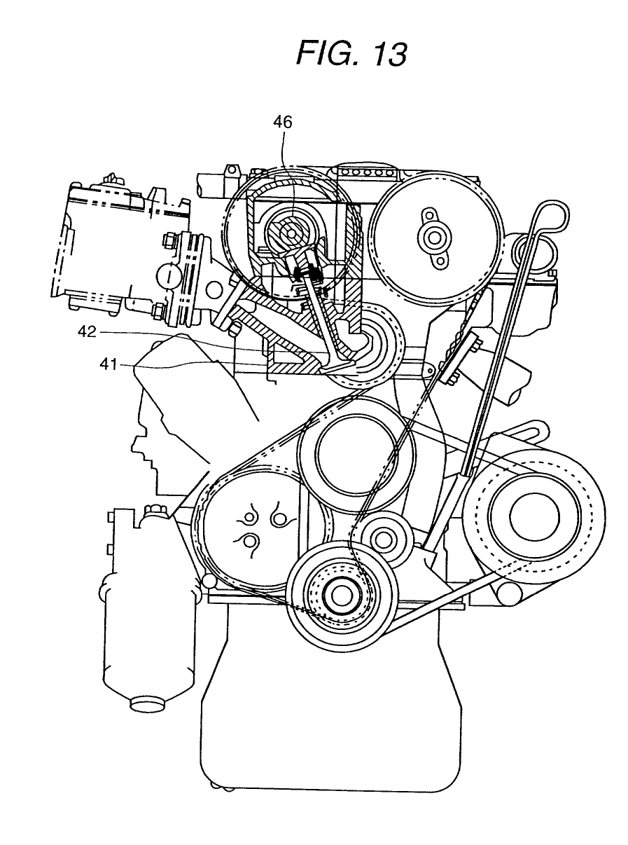

The corrosion-resisting and wear-resisting alloy of the present invention is applied to an internal combustion engine as follows. An internal combustion engine using gasoline as fuel is provided with a cylinder 40 for combusting gasoline as described in FIGS. 13, 14, and 15. The cylinder 40 is closed by a cylinder head 41 at the top. The cylinder head 41 is provided with an intake port and an exhaust port, and the individual intake port and exhaust port are opened/closed by valves 42.

The valves 42 are operated to open/close by a valve system provided on the cylinder head 41. The valve system comprises a spring 43 provided around a driving shaft of the valve 42, a valve lifter 44 connected at the top end of the driving shaft, an adjusting shim 45 provided at the top of the valve lifter 44, a cam 46 which is in contact with the top face of the adjusting shim 45, and a power transmitting mean which drives rotatingly the cam 46 using the output of the engine.

A part of the output of the engine is used to rotate the cam 46 in the valve system. The motion of the cam 46 pushes down the valve lifter 44 through the adjusting shim 45 resisting against the spring 43. The pushing down motion departs the valves 42 downward from valve seats 47 of the individual intake ports and exhaust ports, thereby opening the intake port and the exhaust port where the valves 42 are installed.

As the cam 46 rotates further, the valves 42 come in contact with the valve seats 47 to close the valves 42. The contact parts between the valve seats 47 and valves 42 serve as a seal to prevent the gas inside the cylinder 40 from leaking.

The valve system including this motion presents friction due to a sliding motion between the adjusting shim 45 and the cam 46. Friction also presents between the valve 42 and the valve seat 47. Driving the valve system resisting against these frictions generate a loss in the output of the engine, thereby reducing the engine efficiency.

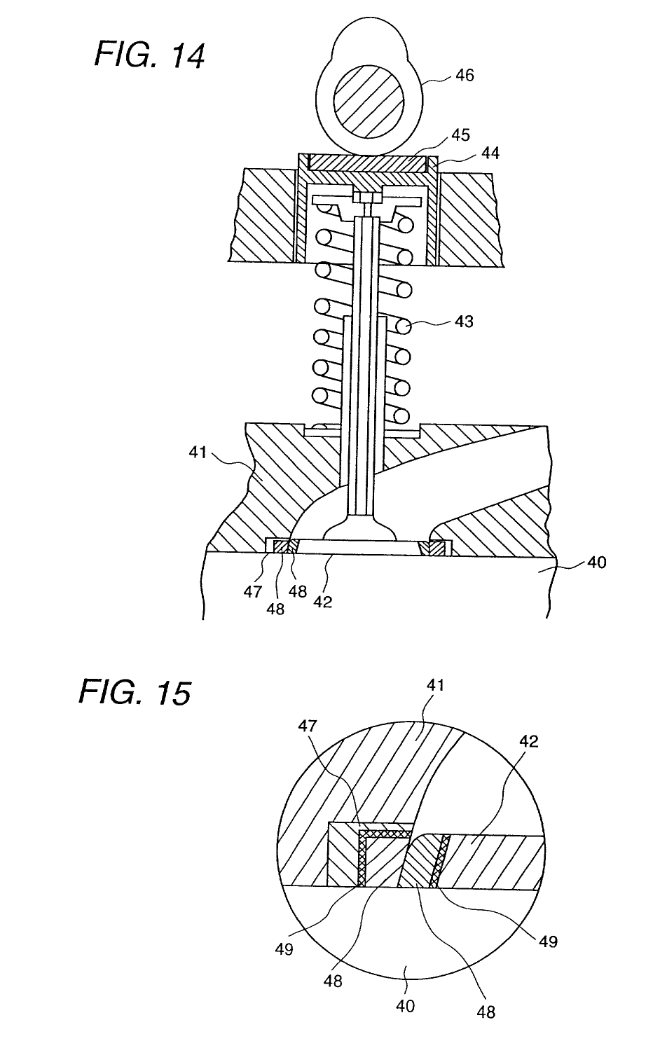

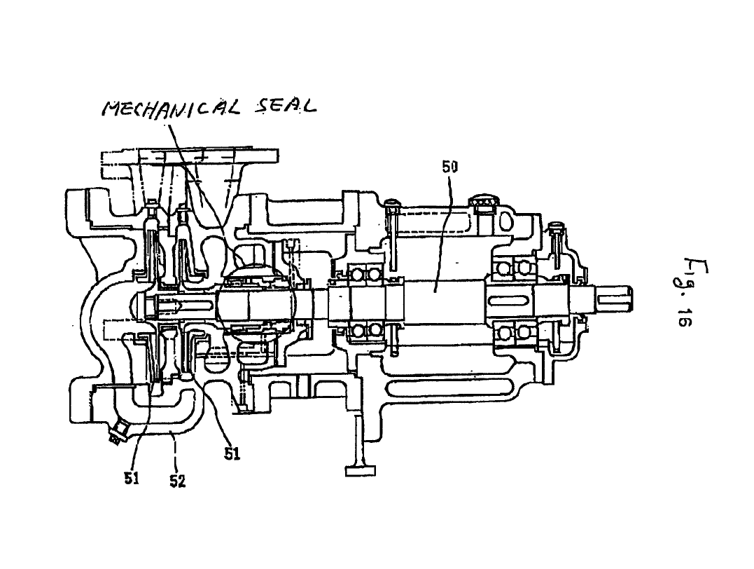

A Co-base alloy 48 as a corrosion-resisting and wear-resisting alloy is joined to the contact parts between the valve 42 and the valve seat 47 in the engine with a liquid phase diffusing welding 49 as indicated in FIGS. 14 and 15. This joining method is conducted as the liquid phase diffusion welding described before, and the same cooling condition is applied. The Co-base alloy 48 is at least heat forged before hand, and is made into a metal structure where the eutectic carbide are composed into multiple grains or clusters in the base material of the cobalt.

The Co-base alloy including the eutectic carbide composed as multiple grains or clusters in the base material is joined with the liquid phase diffusion welding to the top end of the valve lifter 45 to form the adjusting shim 4.

The compositions of the Co-base alloy 48 and the insert material used for the liquid phase diffusion welding is indicated in Table 3.

TABLE 3
(Weight %)

| | Co | Cr | W | C | Fe | Ni | Other |
|---|---|---|---|---|---|---|---|
| Co-base | Bal | 29.4 | 3.9 | 1.0 | 2.7 | 2.4 | Mo0.1/i0.6 |
| alloy | | | | | | | |
| Ni-base | — | 10.0 | 2.0 | 1.0 | 2.5 | Bal | Si5.4 |
| alloy | | | | | | | |
| Fe-base | — | 25.0 | — | 1.0 | Bal | 4.0 | Mo2.0 |
| alloy | | | | | | | |
| Insert | — | — | — | — | — | Bal | Si0.6/B3.0 |
| material | | | | | | | |

During the liquid phase diffusion welding, though the insert material melts, Co-base alloy 48, the valve 42 and the valve seat 47 do not melt. The Co-base alloy 48 after the joining maintains the metal structure where multiple grains or clusters of eutectic carbide are distributed discontinuously in the base material.

After the welding, the eutectic carbide still exists as grains or clusters on the surface or the inside of the Co-base alloy 48. The existence of the grains or clusters of the eutectic carbide in the Co-base alloy 48 limits the exposure of the eutectic carbide, resulting in restraining the damage.

If the Co-base alloy 48 where the eutectic carbide is diffused discontinuously as grains or clusters is exposed to a corrosive environment of sulfur, the grains or clusters of the eutectic carbide which are in contact with the corrosive environment are detached from the surface as the result of the corrosion or the sliding action, and only the base material without the eutectic carbide exists on the surface which is in contact with the corrosive environment. A phenomenon where corrosion and detaching happen alternately and repeatedly is prevented, thereby restraining the damage.

If the coefficient of friction of the Co-base alloy 48 including eutectic carbide composed as grains or clusters is measured at room temperature under high surface pressure (about 2000 kg/cm²), and is indicated as a developed material in a chart, the coefficient of friction is as low as ½ to ⅔ of that of a conventional Co-base alloy having mesh-like eutectic carbide as indicated in FIG. 9.

The engine valve 42 is assumed to be used at a high temperature (up to about 500 to 600° C.) and with a large number of sliding motions. The test result shows the low friction under the high surface pressure. Though the coefficient of friction is governed by the ratio of shearing strength and degree of hardness, the ratio of searing strength and degree of hardness of the material has little dependency on temperature, and it is assumed that no change is observed if materials have the same composition. Thus the effect of the low friction is gained at a high temperature and with a large number of sliding motions.

For comparing the corrosion-resisting capability, Strauss test and an erosion test in diluted sulfuric acid were conducted. As the result, the Co-base alloy 48 (developed material) shows a corrosion-resisting capability 30 times as much as that of the Co-base alloy including eutectic carbide composed as mesh as indicated in Table 1 in the Strauss test. The Co-base alloy shows durability 20 to 30 times as much as that of the Co-base alloy including eutectic carbide composed as mesh in the erosion test in diluted sulfuric acid.

With the present embodiment, high corrosion resistance, low wearing and low friction achieves the durability and the reduction of the power loss of the valve system, thereby increasing efficiency, output and durability of the engine as a whole.

The Co-base alloy adopted for this embodiment can be the Co-base alloy including components described in Table 2, or a Ni-base alloy or a Fe-base alloy which includes grain-like or cluster-like eutectic carbide and is made by hot forging from the Ni-base alloy or the Fe-base alloy having components indicated in Table 3 can replace the Co-base alloy 48, and increases efficiency, output and durability of the engine as a whole.

In this case, a joining mean and a joining condition for joining the Co-base alloy, the Ni-base alloy or the Fe-base alloy to the valve 42 and the valve seat 47 are selected such that the eutectic carbide exists as grains or clusters in the Co-base alloy, the Ni-base alloy or the Fe-base alloy after the joining. The preferable method as the joining mean is liquid phase diffusing welding.

In the.present embodiment, the Co-base alloy, the Ni-base alloy or the Fe-base alloy including grain-like or cluster-like eutectic carbide is joined with the liquid phase diffusion welding to parts having a seal capability on the valve 42 and the valve seat 47 of the engine, thereby providing seal faces having strength, wear-resisting capability, corrosion-resisting capability and low friction while maintaining a high degree of hardness.

Preventing corrosion caused by sulfuric component and the like included in gasoline as the fuel of the engine, a progress of crack starting from the corrosion, and the decrease of the seal capability caused by erosion provide a seal face with a low friction to prevent the decrease of the engine efficiency caused by friction, thereby contributing the increase of the engine output in addition to increasing the durability of an internal combustion engine, and preventing the decrease of the engine efficiency.

Using the liquid phase diffusion welding to join the Co-base alloy, the Ni-base alloy or the Fe-base alloy including grain-like or cluster-like eutectic carbide from Table 2 and Table 3 to an external peripheral surface of the valve lifter 44 constituting the valve system of the engine increases the durability of the engine, and prevents the decrease of the engine efficiency further.

If the Co-base alloy including the mesh-like eutectic carbide is designated as a conventional example, and the Co-base alloy including components shown in Table 2 diffused discontinuously as grains or clusters is designated as the present embodiment, the comparison between the both alloys shows the differences in capability as in Table 4.

TABLE 4

| Evaluated item | Conventional example | Present embodiment |
|---|---|---|
| Tensile strength N/mm² | 920 | 1064 |
| Compressive stress N/mm² | 1700 | More than 1700 |
| Impact value kgm/cm² | 0.2 | 8 to 10 |
| Coefficient of friction | 0.4 | 0.16 to 0.19 |
| Hardness (HRC) | 43 | 43 to 45 |
| SOx corrosion sensitivity | Yes | No |

Since the alloys from the conventional example and the present invention present differences in the capability as described before, if the valve lifter is used after the alloy from the present invention is attached with the liquid phase diffusion welding, the engine output loss caused by the friction in the valve system is reduced. If the valve and the seat are used after the alloy from the present invention is attached with the liquid phase diffusion welding, they do not present corrosion sensitivity under SOx atmosphere and a high impact value, thereby maintaining the health of the valve and the seat.

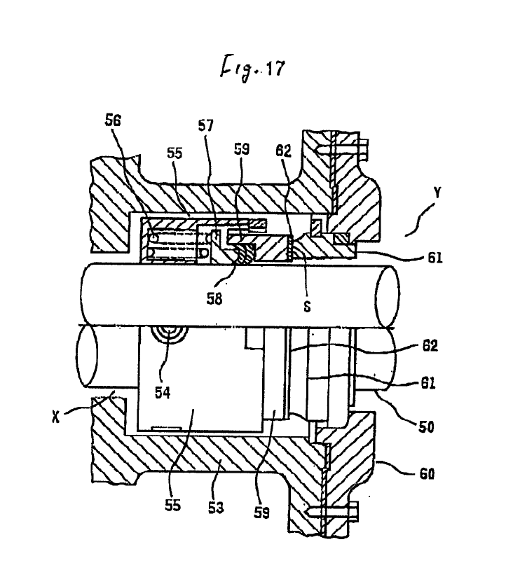

The corrosion-resisting and wear-resisting alloy of the present invention is also applied to a pump facility as described below. In a pump facility shown in FIG. 16, an electric motor or the like rotates a shaft 50, and an impeller 51 fixed to the shaft 50 rotates in a pump casing 52. The rotation of the impeller 51 increase the pressure of liquid X which flows into the pump casing 52, and the liquid X is discharged outward from the pump casing 52.

A mechanical seal is adopted between the liquid X and gas Y to prevent the liquid X from leaking into the gas Y side. The mechanical seal is shown in FIG. 17. The mechanical seal in FIG. 17 is provided with the following constitution.

A fastener 55 is placed in a periphery of the shaft 50 inside a seal box 53 integrated with the pump casing 52. The fastener 55 is fixed to the shaft 50 with a knock 54. In side the fastener 55, a spring 56, a pressing member 57, a packing 58, and a washer 59 are provided around the shaft 50.

A seal cover 60 provided in the periphery of the shaft 50 is attached to an end of the seal box 53. A seat 61 provided in the periphery of the shaft 50 is attached to the seal cover 60.

Since the spring 56 presses the pressing member 57, the packing 58, and the washer 59 toward the right direction, a washer 59 is pressed against the seat 61 at a sealed end face S. Pressing the washer 59 to the seat 61 with the spring 56 seals the liquid X to prevent it from leaking to the gas Y side.

The fastener 55, the spring 56, the pressing member 57, the packing 58, and the washer 59 rotate with the shaft 50, and the seat 61 does not rotate. Heat is generated at the sealed end face S, thereby accelerating seizure, wear, and corrosion at the sealed end face S. Thus, a mechanical seal using a wear-resisting and corrosion-resisting material is needed at the sealed end face.

To satisfy the requirement, in the present embodiment, a plate 62 made of a corrosion-resisting and wear-resisting alloy is attached to a part where the washer 59 comes in contact with the seat 61 as indicated FIG. 17. Either of the alloys described before is applied as the corrosion-resisting and wear-resisting alloy, and the eutectic carbide is distributed discontinuously as grains or clusters in the base of the alloy. The alloy is joined to the washer 59 with liquid phase diffusing welding. The joining method and the joining condition for the liquid phase diffusion welding are the same as those described before. A similar corrosion-resisting and wear-resisting alloy may be attached to a part where the seat 61 comes in contact with the washer 59. The corrosion-resisting and wear-resisting alloy may be attached both to the washer 59 and the seat 61 where they come into contact with each other to make the corrosion-resisting and wear-resisting alloy on the both parts come in contact with at the sealed end face S.

With this embodiment, since the corrosion-resisting and wear-resisting alloy joined to at least either of the washer 59 or the seat 61 includes the grain-like or cluster-like eutectic carbide diffused as a discontinuous distribution, it is maintained such that it hardly develops corrosion, and the coefficient of friction is maintained as low as that of the corrosion-resisting and wear-resisting alloy in FIG. 9.

Increased corrosion resisting capability and decreased friction at the sealed end face S are achieved under a corrosive environment including sulfuric component or dissolved oxygen. With the present embodiment, the capability of the mechanical seal is maintained for a long period, thereby providing a mechanical seal with high reliability. Since the capability of the mechanical seal is maintained for a long period, the reliability of a pump using the mechanical seal and the reliability of a plant using the pump increase.

Conventionally the washer 59 is used after a Co-base alloy is overlaid on the sealed end face S of the washer 59, and the seat 61 is made of carbon impregnated with burnt phenol, carbon formed with phenol, or carbon impregnated with white. The capability of the corrosion-resisting and wear-resisting alloy (Co-base alloy) used for either the washer 59 or the seat 61 or the both of the washer 59 and the seat 61 in the present embodiment where the grain-like or cluster-like eutectic carbide is distributed discontinuously in the base material is compared with that of the conventional example in Table 5. The Co-base alloy in the present embodiment in Table 5 has the components described in Table 2, and the grain-like or cluster-like eutectic carbide are diffused discontinuously in the alloy.

TABLE 5

| | Conventional example | | | | | |
|---|---|---|---|---|---|---|
| | | Seat | | | Embodiment of the | |
| | | Carbon | | | present invention | |
| | | impregnated | Carbon | Carbon | Washer | Seat |
| | Washer | with burnt | formed with | impregnated | Co-base | Co-base |
| Item | Overlay | phenol | phenol | with white | alloy | alloy |
| Tensile | 920 | 2.5 | 3 to 3.5 | — | 1064 | 1064 |
| Strength N/mm² | | | | | | |
| Compressive | 1700 | 8 | 17 to | 14 | More | More |
| Stress N/mm² | | | 17.5 | | than | than |
| | | | | | 1700 | 1700 |
| Impact value kgm/cm² | 0.2 | — | 2 to 3 | — | 8 to 10 | 8 to 10 |
| Coefficient of | 0.4 | — | 0.25 | — | 0.16 to | 0.16 to |
| friction | | | | | 0.19 | 0.19 |
| Hardness (HRC) | 43 | 46 | 37 to 53 | 46 | 43 to | 43 to |
| | | | | | 45 | 45 |
| Withstanding | More | — | 180 | 200 | More | More |
| temperature (° C.) | than | | | | than | than |
| | 300 | | | | 300 | 300 |

With these differences in the capability, the mechanical seal in the present embodiment restrains seizure, wear and corrosion at the sealed end face S. The present embodiment provides a mechanical seal which withstands a compressive stress and an impact value higher than the conventional ones.

After the plate 62 made of the corrosion-resisting and wear-resisting alloy is joined to a washer 59 or the like, the grain-like or cluster-like eutectic carbide exists discontinuously in the base material of the corrosion-resisting and wear-resisting alloy, thereby providing a high corrosion-resisting capability and restraining a leak at the sealed end face S, resulting in preventing erosion at the sealed end face S caused by the leak. The present embodiment provides a mechanical seal with a high capability.

During the operation of the pump facility indicated in FIG. 16, the washer 59 rotates with the rotating shaft 50, and a plate 62 attached to the washer 59 rotates while the plate 62 is in contact with the stationary seat 61 fixed to the pump casing 52. The contact between the plate 62 and the seat 61 provides a seal between the rotating shaft 50, which is a member of the rotating side, and the pump casing 52, which is a member of the stationary side, thereby preventing a leak of liquid. A mechanical seal device in the pump facility comprises the washer 59, the plate 62 and the seat 61. A first seal comprises the washer 59 (main body side) and the plate 62 (the corrosion-resisting and wear-resisting alloy). A second seal comprises the seat 61. The first seal may be provided on the pump casing 52. The second seal may be provided on the rotating shaft 50 side. The second seal provided on the pump casing 52 may be constituted in the same way as that of the first seal.

The plate 62 rotates at a high speed while it is always in contact with the seat 61 with an action of the spring 56 to maintain the sealing capability. Though wear, seizure, and corrosion of the plate 62 forming the seal face are suspected, the plate is excellent in the wear-resisting capability and corrosion-resisting capability since the eutectic carbide is formed as grains or clusters as described before, thereby presenting little wear. The plate 62 is also excellent in corrosion-resisting capability, thereby preventing a corrosion caused by a contact with liquid. This decreases the frequency of maintaining the mechanical seal device, thereby extending the life of the mechanical seal device. This leads to a reduction of maintenance operation of the pump facility. Since the plate 62 constituted with the corrosion-resisting and wear-resisting alloy including grain-like or cluster-like eutectic carbide has coefficient of friction as small as about 0.16, the ratio at which rotating power of the rotating shaft 50 changes into heat energy at the contact part between the plate 62 and the seat 61 is extremely small. The loss of the rotating power of the rotating shaft 50 is small.

The mechanical seal device including a corrosion-resisting and wear-resisting alloy having grain-like or cluster like eutectic carbide such as the plate 62 of the present embodiment is applied to a compressor pressurizing gas and a blower requiring a seal between a rotating shaft and a casing in addition to the pump of the present embodiment, which is a fluid pressurizing device. The compressor and the blower are types of the fluid pressurizing devices. The mechanical seal device is also applied to a turbine where steam flows. The mechanical seal device including a corrosion-resisting and wear-resisting alloy having grain-like or cluster like eutectic carbide, which is applied to the pump facility is applied as a mechanical seal device sealing between a rotating shaft and a casing of the turbine. The pump facility, the compressor, the blower, and the turbine are rotating devices inside which fluid flows.

A preferable concept of the present invention including the pump facility shown in FIG. 16, the compressor, the blower and the turbine is also recognized as in claim 15.

A preferable concept of the present invention including the pump facility shown in FIG. 16, the compressor, and the blower is also recognized as in claim 16. It is also preferable to coincide the concept with the concepts described in claim 17 or claim 20.

What is claimed is:

1. A corrosion-resisting and wear-resisting alloy, which is obtained by selecting a material from cobalt base added with Cr and/or W, nickel base added with Fe and/or Cr, and iron base added with Cr and/or Ni, casting said material into an ingot or a slab as an intermediate material, applying hot plastic forming at a temperature which is 650° C. or more and the solidus temperature or less to said intermediate material,. which includes a structure comprising mesh-like eutectic carbide and a base material surrounded by the eutectic carbide, forming the eutectic carbide as a discontinuous distribution in a form of multiple grains or clusters, wherein the coefficient of friction is 0.1 to 0.5, and the Vickers hardness without age hardening process is 300 to 600 Hv.

2. A corrosion-resisting and wear-resisting alloy according to claim 1, wherein the coefficient of friction is 0.3 or less.

3. A corrosion-resisting and wear-resisting alloy according to claim 1, wherein the cobalt base added with Cr and/or W comprises 0.1 to 3.5% of C, 25% or less of Ni, 25 to 35% of Cr, 5% or less of Fe, 20% or less of W, 1.5% or less of Mo, and 1.5% or less of Si in weight ratio, the balance Co and inevitable impurities.

4. A corrosion-resisting and wear-resisting alloy according to claim 1, wherein the nickel base added with Fe and/or Cr comprises 0.1 to 2.5% of C, 3 to 9% of Si, 7 to 25% of Cr, 0.5 to 5% of B, 2 to 6% of Fe, 1 to 5% of W, and 17% or less of Mo in weight ratio, the balance Ni and inevitable impurities.

5. A corrosion-resisting and wear-resisting alloy according to claim 1, wherein the iron base added with Cr and/or Ni comprises 0.1 to 1.5% of C, 0.3 to 4% of Si, 4 to 9% of Ni, 3% or less of Mo, 6 to 10% of Mn, and 15 to 25% of Cr in weight ratio, the balance Fe and inevitable impurities.

6. A fluid device wherein the corrosion-resisting and wear-resisting alloy according to claim 1 is used for a wear-resisting part or an erosion shield part.

7. A fluid device wherein the corrosion-resisting and wear-resisting alloy according to claim 1 with the coefficient of friction of 0.1 to 0.3 is used for a wear-resisting part or an erosion shield part.

8. A dynamic device wherein the corrosion-resisting and wear-resisting alloy according to claim 1 is joined with a base metal without changing the metal composition for application to a sliding part or a contact part.

9. A dynamic device wherein the corrosion-resisting and wear-resisting alloy according to claim 1 with the coefficient of friction of 0.1 to 0.3 is joined with a base metal without changing the metal composition for application to a sliding part or a contact part.

10. A valve, which is provided with a valve element and a valve casing, wherein valve seats are provided on contact faces of both of the valve element and the valve casing, and a base body of said valve seats is provided with a member which comprises one type of alloy selected from a cobalt-base alloy, a nickel-base alloy, and an iron-base alloy, in which grain-like or cluster-like eutectic carbide is diffused as a discontinued distribution, and which has the coefficient of friction of 0.1 to 0.3.

11. A nuclear power plant, which is provided with a piping system including a valve on a piping through which a coolant flows, wherein said valve is a valve according to claim 10.

12. A pump wherein a seat and a washer, which relatively rotate about a rotating shaft of the pump, are in contact with each other at a sealed end, and either of the contact faces of the said seat or said washer is provided with a member which comprises one type of alloy selected from a cobalt-base alloy, a nickel-base alloy, and an iron-base alloy, in which grain-like or cluster-like eutectic carbide is diffused as a discontinued distribution, and which has the coefficient of friction of 0.1 to 0.3.

13. An internal combustion engine, wherein a valve seat part and a valve are provided on a cylinder head of said internal combustion engine, valve seats are respectively provided on contact faces of both of said valve seat part and said valve, and surfaces of base bodies of said valve seats is provided with a member which comprises one type of alloy selected from a cobalt-base alloy, a nickel-base alloy, and an iron-base alloy, in which grain-like or cluster-like eutectic carbide is diffused as a discontinued distribution, and which has the coefficient of friction of 0.1 to 0.3.

14. An internal combustion engine, wherein at least either of contact faces of a valve lifter or a cam of the internal combustion engine is provided with a member which comprises one type of alloy selected from a cobalt-base alloy, a nickel-base alloy, and an iron-base alloy, in which grain-like or cluster-like eutectic carbide is diffused as a discontinued distribution, and which has the coefficient of friction of 0.1 to 0.3.

15. A rotating device comprising:
a casing in which liquid flows;
a rotating shaft which is inserted into said casing; and
a mechanical seal device which seals between said rotating shaft and said casing;
wherein said mechanical seal device is provided with a first seal, which rotates with said rotating shaft, and a second seal, which is provided on said casing and is in contact with said first seal, at least either of said first seal or said second seal includes a corrosion-resisting and wear-resisting alloy where grain-like or cluster-like eutectic carbide is diffused in a matrix part of a metal micro structure, and which is in contact with the other seal, and a main body, and said corrosion-resisting and wear-resisting alloy is diffusion-welded to said main body.

16. A liquid pressurizing device comprising:
a casing;
a rotating shaft inserted into said casing;
a fluid pressurizing mean which is provided on said rotating shaft and pressurizes fluid; and
a mechanical seal device which seals between said rotating shaft and said casing;
wherein said mechanical seal device is provided with a first seal, which rotates with said rotating shaft, and a second seal, which is provided on said casing and is in contact with said first seal, at least either of said first seal or said second seal includes a corrosion-resisting and wear-resisting alloy where grain-like or cluster-like eutectic carbide is diffused in a matrix part of a metal micro structure, and which is in contact with the other seal, and a main body, and said corrosion-resisting and wear-resisting alloy is diffusion-welded to said main body.

17. A liquid pressurizing device according to claim 16 wherein said corrosion-resisting and wear-resisting alloy has 0.1 to 0.3 of coefficient of friction, and 300 to 600 Hv of Vickers hardness without age hardening process.

18. A liquid pressurizing device according to claim 17 wherein said corrosion-resisting and wear-resisting alloy is constituted with a cobalt base material added with Cr and/or W comprises 0.1 to 3.5% of C, 25% or less of Ni, 25 to 35% of Cr, 5% or less of Fe, 20% or less of W, 1.5% or less of Mo, and 1.5% or less of Si in weight ratio, the balance Co and inevitable impurities.

19. A liquid pressurizing device according to claim 17 wherein said corrosion-resisting and wear-resisting alloy is constituted with a nickel base material added with Fe and/or Cr comprises 0.1 to 2.5% of C, 3 to 9% of Si, 7 to 25% of Cr, 0.5 to 5% of B, 2 to 6% of Fe, 1 to 5% of W, and 17% or less of Mo in weight ratio, the balance Ni and inevitable impurities.

20. A liquid pressurizing device according to claim 17 wherein said corrosion-resisting and wear-resisting alloy is constituted with an iron base material added. with Cr and/or Ni comprises 0.1 to 1.5% of C, 0.3 to 4% of Si, 4 to 9% of Ni, 3% or less of Mo, 6 to 10% of Mn, and 15 to 25% of Cr in weight ratio, the balance Fe and inevitable impurities.
